(19) United States
(12) Patent Application Publication
(10) Pub. No.: US 2007/0092662 A1
(43) Pub. Date: Apr. 26, 2007

(54) HIGHLY DURABLE POLARIZATION PLATE AND LIQUID CRYSTAL DISPLAY

(75) Inventors: Kenji MATSUNO, Niihama-shi (JP); Toshiya Inoue, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/469,938

(22) Filed: Sep. 5, 2006

(30) Foreign Application Priority Data
Sep. 7, 2005 (JP) 2005-258960
Jun. 26, 2006 (JP) 2006-174920

(51) Int. Cl. C09K 19/00

(52) U.S. Cl. 428/1.3

(57) ABSTRACT

The present invention provides a polarizer comprising a polarizing film, a first transparent protective film and a second transparent protective film, the polarizing film being between the first transparent protective film and the second transparent protective film, wherein the first transparent protective film has a water-vapor permeability of 50 g/m²·24 hours or less at 40° C. under a relative humidity of 90 % and a water content of the polarizer is 2.0% by weight or less.

### FIELD OF THE INVENTION

The present invention relates to polarizers with excellent durability for liquid crystal displays. The invention also relates to liquid crystal displays using the polarizers.

### BACKGROUND OF THE INVENTION

Recently, liquid crystal displays are commonly used for automobiles and cellular phones, and are required reliability under such environments as to be high temperature or high temperature and humidity. In particular, when they are used for automobiles, durability under very severe conditions is desired such that no deterioration is caused in their performance even under exposure of a high temperature in summer.

Liquid crystal displays are generally constructed as follows; placing two electrode substrates having a transparent electrode in an arrangement of their transparent electrodes facing to each other, inserting a liquid crystal therebetween to form a liquid crystal cell, and then affixing a polarizer on the one or both faces of the liquid crystal cell. Regarding to such polarizer, the polarizer is generally produced as follows; adsorbing iodine or dichromatic dyes into a polyvinyl alcohol, stretching and orientating a film of the polyvinyl alcohol to form a polarizing film, and then both faces of the resultant polarizing film being affixed with a film of cellulose resins typically such as triacetylcellulose (TAC) as a protective layer.

Because they are easily permeated by water due to their generally high water-vapor permeability, the color of the polarizing films made of cellulose resins is retarded as well as their hue is changed or their polarity is decreased under exposure of anti wet-heat environments.

Accordingly, it is attempted to reduce the water-vapor permeability of a protective film of a polarizer; for example, the use of a resin having a lower water-vapor permeability than the cellulose resins, or reducing the water-vapor permeability of the protective film by providing a surface treatment to an exposed surface of the cellulose resins.

Followings are technologies of constituting a protection film with a resin having a low water-vapor permeability: Japan Patent No. S59-159109A (Patent Literature 1) discloses an improvement of the durability of a polarizer wherein a mono-oriented polymer film with a water-vapor permeability of 10 g/m² day or less, specifically a mono-oriented high density polyethylene film or polypropylene film, is disposed as a protective film on the both faces of a polyvinyl alcohol polarizing film with a water content of 5% or less; and Japanese Patent No. S60-159704A (Patent Literature 2) also discloses an improvement of the durability of a polarizer wherein a transparent protective film which has a water-vapor permeability of 55 g/m² hr or less at 80° C. under a relative humidity of 95% and a dimensional change ratio of −0.3 to 0% after being heated at 100° C. for 30 minutes, specifically a film of resins such as polymethyl methacrylate, polyethersulfone, or polycarbonate, is disposed at least one side of a polyvinyl alcohol polarizing film. Japanese Patent No. H7-77608A (Patent Literature 3) further discloses an improvement of the durability of a polarizer wherein a protective film which has a water-vapor permeability of 200 g/m^{2·}24 hours 100 μm or less at 80° C. under a relative humidity of 90% and a photoelastic coefficient of 1×10⁻¹¹ cm²/dyne or less, specifically a film of thermoplastic saturated norbornene resins, is affixed at least one side of a polyvinyl alcohol polarizing film.

Japanese Patent No. 2003-183417A (Patent Literature 4) discloses a cellulose ester film wherein the cellulose ester, by blending a plasticizer such as rosin resins, epoxy resins, ketone resins, or toluenesulfonamide resins, is caused in its mass change to be 0 to 2% after treatment at 80±5° C. under a relative humidity of 90±10% for 48 hours and in its water-vapor permeability to be 50 to 250 g/m²·24 hours.

Followings are technologies of providing surface treatment on an exposed surface of cellulose resins to reduce the water-vapor permeability of a protective film: Japanese Patent No. 2004-53797A (Patent Literature 5) discloses that a hard organic resin layer and an antireflection layer of a plurality of inorganic compounds with different refractive indexes are layered in this order on a plastic resin substrate to form an antireflection film, thereby the resultant antireflection film has a water-vapor permeation rate at 60° C. under a relative humidity of 95% of which value is half or less than that of the plastic resin substrate and 500 g/m²/day or less; and Japanese Patent No. 2004-341541A (Patent Literature 6) discloses an optically functional film with excellent moisture resistance and the like wherein a silicon oxide film is formed on a transparent substrate film with CVD (Chemical Vapor Deposition) method.

Disposing any of such protective films having low water-vapor permeability to at least one side or particularly the outmost side of a polyvinyl alcohol polarizing film, this exhibits an excellent durability under a wet-heat environment; however, if this is exposed under a high temperature environment with low humidity, this causes deterioration in its appearance such as generation of wrinkled surface defects, resulting in problems such as adverse effects on displaying ability of liquid crystal displays.

For example, Japanese Patent No. 2000-321428A (Patent Literature 7) notes that, when a polarizer is disposed with an antireflection layer on a surface of a protective film thereof, a heat resistance thereof often becomes insufficient, and that this is caused by the reduction of the water-vapor permeability due to disposing the antireflection layer, therefore, in this literature, provides a polarizer having a water-vapor permeability of 10 g/m²·24 hours or more even though the polarizer has an antireflection layer.

On the contrary, there is a case that a liquid crystal compound is coated on a surface of a transparent support of cellulose resins to form an optical compensation layer, followed by disposing the optical compensation layer on one side of a polarizing film as a protective film. In this case, an oriented film is generally formed in advance on the transparent support to align the liquid crystal compound in a predetermined direction. For example, Japanese Patent No. H9-179125A (Patent Literature 8) discloses that an oriented film is provided on a transparent support to obtain a support with oriented film, followed by providing an optical anisotropic layer (optical compensation layer) composed of a discotic compound on the oriented film to form an optical compensation sheet.

Materials for a oriented film have to be suitably selected considering their aligning ability, coating ability, optical property, and durability; however, material with insufficient water resistance is often selected due to the requirement of the aligning ability and coating ability. For example, the Patent Literature 8 mentioned above recommends polyvinyl alcohol as a material of an oriented film. When the oriented film or coating layer is composed of materials with insufficient water resistance, a durability of the obtained polarizer under an environment containing a lot of water is insufficient, thereby often causes troubles on liquid crystal displays under high temperature and high humidity conditions. Specifically, when any of layers constituting a polarizer deteriorate their expected adhesion strength due to water, rest of the layers generate external stresses while they expand or contract with thermal or moisture absorption-desorption effects, thus the stresses often cause delamination between the layers or destruction by themselves.

### SUMMARY OF THE INVENTION

One of the objects of the invention is to develop a polarizer for liquid crystal displays which has a low water-vapor permeability capable of protecting a polarizing film from moisture even under wet-heat environments as well as does not cause deterioration in its appearance and maintains favorable displaying quality under environments of a high temperature with a low humidity.

Another object of the invention is to develop a polarizer being less affected by water even if the polarizer has a layer with low water resistance.

The invention, in view of the first aspect, provides a polarizer comprising a polarizing film, a first transparent protective film and a second transparent protective film, the polarizing film being between the first transparent protective film and the second transparent protective film, wherein the first transparent protective film has a water-vapor permeability of 50 g/m²·24 hours or less at 40 C under a relative humidity of 90% and a water content of the polarizer is 2.0% by weight or less.

The first transparent protective film preferably has a surface-treated face opposite to the polarizing film. The first transparent protective film may be subjected to a surface treatment to have a water-vapor permeability of the value described above, when the first transparent protective film originally has a high water-vapor permeability. In this case, the first transparent protective film may be cellulose resins such as triacetylcellulose. This transparent protective film often contains 3 to 10% by weight of triphenylphosphate as a plasticizer to improve moldability. Furthermore, when the first transparent protective film is subjected to a surface treatment, an antireflection layer of metal compounds may be provided on the surface by a sputtering to reduce the water-vapor permeability.

The second transparent protective film which interposes the polarizing film together with the first transparent protective film may have an optical compensation layer opposite to the polarizing film to compensate a view angle.

The invention, in view of the second aspect, also provides a polarizer comprising a polarizing film, a first transparent film and a second transparent protective film, the polarizing film being between the first transparent protective film and the second transparent protective film, wherein the first transparent protective film has a water-vapor permeability of 50 g/m²·24 hours or less at 40° C. under a relative humidity of 90%, and the second transparent protective film has layer of a transparent support including a cellulose resin, a hydrophilic oriented film, and a coating layer of a liquid crystal compound in this order and affixed to the polarizing film at the side of the transparent support thereof.

In this polarizer, the first transparent protective film also preferably has a surface-treated face opposite to the polarizing film.

The first transparent protective film preferably has a surface-treated face opposite to the polarizing film. The first transparent protective film may be subjected to a surface treatment to have a water-vapor permeability of the value described above, when the first transparent protective film originally has a high water-vapor permeability. In this case, the first transparent protective film may be cellulose resins such as triacetylcellulose. This transparent protective film often contains 3 to 10% by weight of triphenylphosphate as a plasticizer to improve moldability. Furthermore, when the first transparent protective film is subjected to a surface treatment, an antireflection layer of metal compounds may be provided on the surface by a sputtering to reduce the water-vapor permeability.

Furthermore, the hydrophilic oriented film of the second transparent protective film may be composed of a polyvinyl alcohol resin. The coating layer of a liquid crystal compound which constitutes the second transparent protective film may be an optical compensation layer including a discotic liquid crystal. The optical compensation layer may be a negative birefringent layer including a liquid crystal compound with discotic structural units, wherein a disk face of the discotic structural units may be tilted with respect to the plane of the transparent support, and an angle formed by the disc face of the discotic structural units and the plane of the transparent support may vary along the thickness direction of the optical compensation layer. The angle formed by the disc face of the discotic structural units and the plane of the transparent support preferably increases as a distance in the optical compensation layer from the transparent support increases along the thickness direction of the optical compensation.

Moreover, a pressure-sensitive adhesive layer may be provided on an outer side of the coating layer of a liquid crystal compound which constitutes the second transparent protective film, in order for affixing to a liquid crystal cell.

The invention, in view of the third aspect, further provides a liquid crystal display including any of the polarizer mentioned above and a liquid crystal cell, wherein the polarizer is affixed to one of the faces of the liquid crystal cell with the side of the second transparent protective film thereof via a pressure-sensitive adhesive layer.

The polarizer of the invention has an excellent ability to block moisture, this allows the polarizer to retain its optical qualities under wet-heat environments, and, by controlling water content in the polarizer, to avoid deterioration in its appearance such as generation of wrinkled defects even under dried and high temperature environments. Consequently, the polarizer is suitably used for liquid crystal displays, thereby effectively enhances image displaying quality and reliable durability of the displays.

Furthermore, the polarizer according to the second aspect, although it has a hydrophilic oriented film in the second transparent protective film, can drastically suppress effects of hydrophilicity on the oriented film by virtue of reducing the water-vapor permeability of the first transparent protective film.

### BRIEF DESCRIPTION OF THE DRAWINGS

FIG. 1 is a sectional schematic view depicting an example of a layer structure of a polarizer of the invention.

FIG. 2 is a sectional schematic view depicting an example of another layer structure of a polarizer of the invention.

FIG. 3 is a sectional schematic view depicting a method for producing a polarizer in Example 1.

FIG. 4 is a sectional schematic view depicting a method for producing a polarizer in Comparative Example 1.

FIG. 5 is a schematic view depicting a test method for measuring a water permeability in Example 2 and Comparative Example 2.

FIG. 6 is a graph depicting states of water-vapor permeation in Example 2.

FIG. 7 is a graph depicting states of water-vapor permeation in Comparative Example 2.

FIG. 8 is a referential picture depicting tunnelings observed in Comparative Example 3.

1: Polarizing film
2: First transparent protective film
3: Second transparent protective film
3a: Transparent support
4: Surface-treated layer
5: Hard coated layer
6: Antireflection layer formed by a sputtering
7: Optical compensation layer
8: Oriented film
9: Coating layer of a liquid crystal compound
10: Pressure-sensitive adhesive layer
20: Polarizer
21: Glass vessel
22: Temperature-humidity meter
25: Tunnelings observed on a surface of a polarizer

### DETAILED DESCRIPTION OF THE PRESENT INVENTION

An example of the layer structure of the polarizer of the invention is shown in sectional schematic views of FIG. 1. FIG. 1(A) shows a basic layer structure, in which a polarizing film 1 is interposed between transparent protective films 2 and 3 to constitute a polarizer. In the invention, the first transparent protective film 2, which is one of two transparent protective films interposing the polarizing film 1, has a water-vapor permeability of 50 g/m²·24 hours or less at 40° C. under a relative humidity of 90%, and, in the case of the polarizer defined by the first aspect, a water content of the whole of the polarizer is 2.0% by weight or less. FIG. 1(B) shows an example that the basic layer structure shown in FIG. 1(A) is provided with preferable additional layers. As shown in the above figure, a surface-treated layer 4 may be provided at an outer side of the first transparent protective film 2, in other words, at the side opposite to the polarizing film 1. The second transparent protective film 3 may be provided, especially on an outer side thereof, with an optical compensation layer 7. The optical compensation layer 7 may be provided via an oriented film. When the polarizer having the layer structure shown in FIG. 1 is applied to a display, the second transparent protective film 3 or the optical compensation layer 7 is disposed to a side of a liquid crystal cell, and the first transparent protective film 2 or surface-treated layer 4 is disposed to a viewing side. Therefore, at the outer side of the second transparent protective film 3 or optical compensation layer 7, i.e. at the side opposite the polarizing film 1, a pressure-sensitive adhesive layer 10 may be provided for affixing with a liquid crystal cell. Each of layers shown in FIG. 1 is explained as follows.

The polarizing film 1 is an optical device which transmits a linearly polarized light vibrating in a plane with a specific direction and absorbs another linearly polarized light vibrating in a plane orthogonal to the former plane. As a specific example, included is a film of polyvinyl alcohol resin adsorbing and orienting a dichromatic dye. Polarizing films include an iodine polarizing film adsorbing and orienting an iodine element as the dichromatic dye or a dye polarizing film adsorbing and orienting a dichromatic organic dye as the dichromatic dye, and any of them may be used.

The transparent protective films 2 and 3 may use any resin film which are conventionally used. In the invention, the transparent protective films 2, which is the one of them, is caused to have a water-vapor permeability to 50 g/m²·24 hours or less at 40° C. under a relative humidity of 90%. A value of water-vapor permeability can be determined according to a code JIS Z 0208. According to the code, the water-vapor permeability should be measured at a temperature of either 25° C. or 40° C.; thus, the temperature of 40° C. is applied in the specification. And, the measurement is also conducted with a sampled film on the basis of an area of 28.3 cm³ (a diameter of 6 cm) and a thickness of the film itself, and the resultant water-vapor permeability is represented with the value determined under these conditions.

As a transparent protective film with low water-vapor permeability, a film of thermoplastic resins of which water-vapor permeability is originally low may be used, for example, the resins such as polyolefins, polymethyl methacrylates, polycarbonates, polyethylene terephthalates, cyclic-olefinic resins (norbornene resins). As alternative, may be used resin films of which water-vapor permeability is originally high but allowed to be contained in a range defined by the invention by virtue of a surface treatment and the like. The resin films with originally high water-vapor permeability may include films of cellulose resins such as triacetylcellulose and diacetylcellulose. The original water-vapor permeability of the triacetylcellulose film itself, depending on the kinds thereof, is about 300 to about 550 g/m²·24 hours with the film thickness of about 80 μm.

The transparent protective films 2 and 3, especially the film of cellulose resins such as triacetylcellulose, are often blended with 3 to 10% by weight of triphenylphosphate as a plasticizer for enhancing moldability. Content of the triphenylphosphate is quantitatively determined by an absolute calibration curve method of gas chromatography after the triphenylphosphate contained is eluted from a sample and re-precipitated to be isolated, followed by concentration and exsiccation. When at least one of the transparent protective films interposing the polarizing film contains triphenylphosphate as a plasticizer and reduces a water-vapor permeability of the protective film, the polarizer may cause deterioration in its appearance such as wrinkled defects under high temperature environments. Therefore, when such protective film is used, the way of the invention, that is, reducing a water content of the whole of the polarizer to suppress appearance deterioration under high temperature environments, is effective.

The transparent protective film may include plasticizers other than triphenylphosphate, for example, such as other phosphate plasticizers and phthalate plasticizers, and further include additives such as benzophenone or benzotriazol ultraviolet absorbing agents.

A surface treatment method which provides a strength as well as a low water-vapor permeability to the transparent protective film includes a hard coating treatment which serves to provide smoothness or unevenness. A hard coated layer is not particularly limited, exemplified by resin materials themselves such as silicone, acrylic, and urethane-acrylate resins, or compounds of the above-mentioned resins blended with fillers. These hard coated layers may be formed by coating with known methods such as spin coating and microgravure coating, followed by curing. A thickness of the hard coated layer is about 1 to about 30 μm, preferably 3 μm or more and 20 μm or less. A refractive index thereof is usually 1.65 or less, and preferably in the rage of 1.45 to 1.65.

The hard coated surface, for providing antireflecting function as well as exactly reducing a water-vapor permeability, may be provided with a layer of organic materials, metals, or metal compounds with known methods such as microgravure coatings, vapor depositions or sputterings. For reducing a water-vapor permeability, particularly preferable is a method of forming a metal compound film on the hard coated surface with a sputtering.

The organic materials used for forming or coating a film may include polymers containing fluorine atom(s). As the metals, aluminum, silver, and the like are preferably used. The metal compounds are generally in inorganic state, and inorganic oxides, inorganic sulfides, and inorganic fluorides may be used. Examples of the inorganic oxides may include silicon oxide, zinc oxide, titanium oxide, niobium oxide, cerium oxide, indium oxide-tin, tungsten oxide, molybdenum oxide, antimony oxide, aluminum oxide, zirconium oxide, and the like. Examples of the inorganic sulfides may include zinc sulfide, antimony sulfide, and the like. Examples of the inorganic fluorides may include aluminum fluoride, barium fluoride, calcium fluoride, cerium fluoride, aluminum fluoride, lanthanum fluoride, lead fluoride, lithium fluoride, magnesium fluoride, niobium fluoride, samarium fluoride, sodium fluoride, strontium fluoride, yttrium fluoride, and the like. When providing an antireflection layer, at least one layer is required, but multi layers are possible depending on requirements.

An example of the protective film with a suitable surface treatment include a film having double layers, wherein the lower layer is a transparent acrylic hard coating layer to provide a strength and antireflecting function and the upper layer is an antireflection layer consisting of a metal compounds formed with a sputtering.

The second transparent protective film 3 may have either high or low water-vapor permeability, and, in general, preferably has a relatively high water-vapor permeability; specifically, preferable is one having a value of more than 50 g/m²·24 hours at 40° C. under a relative humidity of 90%. An ingredient applied to this transparent protective film 3 may be same to or different from that to the first transparent protective film 2.

The second transparent protective film 3 may be provided with an optical compensation layer 7 to compensate a phase difference which is caused by mounting the polarizer on a liquid crystal display. The optical compensation layer includes, for example, the followings; films with an in-plane directional phase difference stretching a film of resins such as polycarbonate resins, polysulfone resins, polyarylate resins, triacetylcellulose, diacetylcellulose, cyclic polyolefin resins; films with a thickness-directional phase difference which is expressed by forming a coating layer of an inorganic layer compound; and optical compensation films formed with a coating layer of a liquid crystal compound. Commercially available optical compensation films with a coating layer of a liquid crystal compound include “Wide View” film (often referred to as “WV film”) produced by Fuji Photo Film Co., Ltd. and “Nippon Oil NH Film” produced by Nippon Oil Corporation. As alternative, the optical compensation layer 7 may play a role of transparent protective film by affixing the optical compensation layer 7 directly on the polarizing film 1. Since a coated-type optical compensation layer is generally formed directly or via an oriented film on a transparent support composed of cellulose resins depending on requirements, this layer may be affixed to the polarizing film 1 with the side of the transparent support.

An angle formed by a slow axis of the optical compensation layer 7 and an absorption axis of the polarizing film 1 is not particularly limited, and appropriately adjusted according to specifications of a liquid crystal display to be used. It is preferable that affixing the optical compensation layer 7 more effectively allows to suppress formation of color dropout in comparison with conventional one layering a polarizer and retardation film.

The transparent protective films 2 and 3 may be a film satisfying a criteria of water-vapor permeability defined in the invention, and preferably a film further with high transparency and heat resistance; and the transparency is 80% or more in terms of light transmittance, and preferably 85% or more; and the heat resistance is 100° C. or more in terms of glass-transition temperature, and preferably 120° C. or more. Therefore, preferable protective film includes, for example, films of plastics such as triacetylcellulose (TAC) and polyethylene terephthalate.

In the polarizer defined by the first aspect of the invention, a water content of the whole of the polarizer is adjusted to 2.0% by weight or less, the polarizer being constituted by interposing the polarizing film 1 between the first transparent protective film 2 and second transparent protective film 3. Although a water content in a polarizer generally exhibits a high value such as about 2.5% by weight, in the invention, by means of eliminating water contained in a polarizer, the polarizer does not cause deterioration in its appearance even if exposed under a high temperature.

In order to suppress the water content of the polarizer to the low level described above, applied are a method of sufficiently drying the polarizing film in its production step, a method of eliminating water after being the polarizer, or the like. The method of eliminating water after being the polarizer may apply conventional means; for example, such as a vacuum drying and high temperature drying.

The water content of the polarizer defined here is a value calculated according to the following formula (1) based on the weights of the polarizer measured before and after drying the polarizer by exposing under an atmosphere of 100° C. for 0.5 hours.

$$Water content = \frac{( Weight before drying ) - ( Weight after drying )}{( Weight before drying )} \times 100 ( \% ) \qquad ( I )$$

A pressure-sensitive adhesive layer 10 may be composed of adhesive resins such as acrylic resin, which are known as a pressure-sensitive adhesive agent, also called as an adhesive agent.

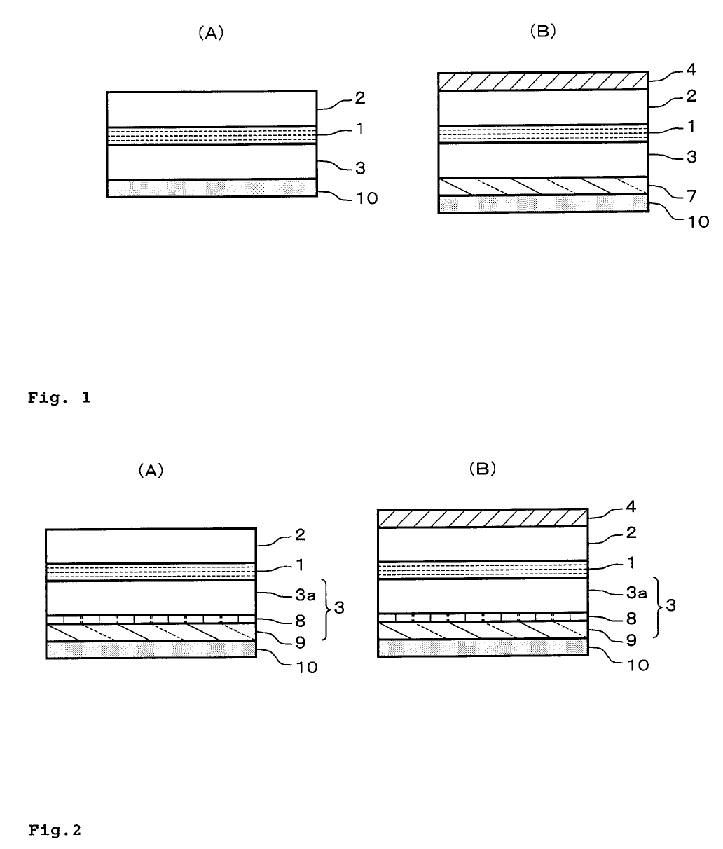

The polarizer defined by the second aspect mentioned above is explained as follows. The basic structure of the polarizer defined by the second aspect is shown in FIG. 2(A), wherein the polarizer is constituted by interposing the polarizing film 1 between the first transparent protective film 2 and second transparent protective film 3. The first transparent protective film 2 is explained with the same explanation mentioned above for the polarizer defined by the first aspect, and a surface-treated layer 4 is preferably disposed at the outer side thereof, i.e. at the side opposite to the polarizing film 1, as shown in FIG. 2(B). Since FIG. 2(B) is same as FIG. 2(A) except for disposing the surface-treated layer 4 at the outer side of the first transparent protective film 2, the portions of FIG. 2(B) which correspond to those of FIG. 2(A) are marked with the same numerical symbols to avoid duplicated explanation. At the outer side of the second transparent protective film, i.e. at the outer side of the coating layer 9 of a liquid crystal compound, a pressure-sensitive adhesive layer 10, which is same as explained above by referring FIG. 1, may be provided to allow to affix with a liquid crystal cell.

The first transparent protective film 2 may be a film originally having a low water-vapor permeability, the film being typically represented by films of cyclo-olefinic or olefinic resins; or a film, which itself originally has a high water-vapor permeability typically such as triacetylcellulose, reducing its water-vapor permeability as a whole films by providing a surface-treated layer 4 exemplified in FIG. 2(B). Films composed of cellulose resins such as triacetylcellulose are often blended with 3 to 10% by weight of triphenylphosphate as a plasticizer.

The second transparent protective film 3 is formed by layering a transparent support 3a including a cellulose resin, a hydrophilic oriented film 8, and a coating layer 9 of a liquid crystal compound in this order and affixed to the polarizing film 1 at the 3a side of the transparent support.

The oriented film 8 is composed of hydrophilic resins such as polyvinyl alcohol resins. The polyvinyl alcohol resins may be modified polyvinyl alcohols, for example, being introduced with alkyl group. The oriented film 8 is usually produced by forming a coating layer composed of such hydrophilic resins on the transparent support 3a, followed by subjecting the surface of the layer to rubbing treatment.

The coating layer 9 of a liquid crystal compound may be an optical compensation layer in which a coating solution containing a discotic liquid crystal is coated and oriented. The optical compensation layer is preferably a negative birefringent layer including a liquid crystal compound with discotic structural units, wherein a disk face of the discotic structural units is tilted with respect to the plane of the transparent support and an angle formed by the disc face of the discotic structural units and the plane of the transparent support varies in the depth direction of the optical compensation layer. In this angular formation, so-called hybrid alignment may be also effective, wherein the angle formed by the disc face of the discotic structural units and the plane of the transparent support increases as a distance in the optical compensation layer from the transparent support increases in the depth direction of the optical compensation. In such formation, the angle formed by the disc face of the discotic structural units and the plane of the transparent support may sequentially increase with starting from the side of the transparent support within the range of about 5 to about 50 degree. Specific examples of an optical compensation film which forms an oriented film and a coating layer of a discotic liquid crystal on a transparent support include “Wide View” film (often referred to as “WV film”) produced by Fuji Photo Film Co., Ltd. and the like.

A polarizer is formed by affixing an optical compensation film on one side of the polarizing film and a transparent protective film composed of a usual triacetylcellulose on the other side of the polarizing film wherein the optical compensation film is constructed by forming a hydrophilic oriented film on a transparent support composed of cellulose resins such as triacetylcellulose and further forming a coating layer of a liquid crystal compound on the formerly formed film; in this polarizer, a phenomena has been possibly observed that, when being exposed under high temperature and humidity conditions, the moisture affects the hydrophilic oriented film and causes a part of the oriented film to blister up from the coating layer of a liquid crystal compound at an edge of the polarizer, thereby a tunnel-shaped blistering (void) starts at the edge and propagates into the inside of the polarizer. Hereinafter, such phenomena may be referred to as a tunneling.

The invention has achieved to prevent a polarizer from the tunneling mentioned above with using a polarizer wherein the polarizer is formed by preparing a film which layers a hydrophilic oriented film and a coating layer of a liquid crystal in this order on a transparent support composed of a cellulose resin, affixing this film on one side of a polarizing film as a second transparent protective film, and also affixing another first transparent protective film on the other side of the polarizing film, wherein the first transparent protective film has a water-vapor permeability equal to or less than the predetermined value at 40° C. under a relative humidity of 90%. Such tunneling is caused in spite of the amounts of water content of the whole polarizer mentioned above. Therefore, in the invention, the polarizer defined by the second aspect does not need to regulate the water content of the whole polarizer. However, since lower water content can suppress deterioration in appearance such as wrinkled defects which is often caused under high temperature environments as explained in the polarizer defined by the first aspect, the lower water content of the whole polarizer is preferable even for the polarizer defined by the second aspect.

### EXAMPLES

The invention will be explained in more detail by referring Examples, but should not be construed to be limited thereto. Since any values of the water-vapor permeability in Examples were determined at 40° C. under a relative humidity of 90%, descriptions of the temperature and humidity are omitted therein.

### Example 1

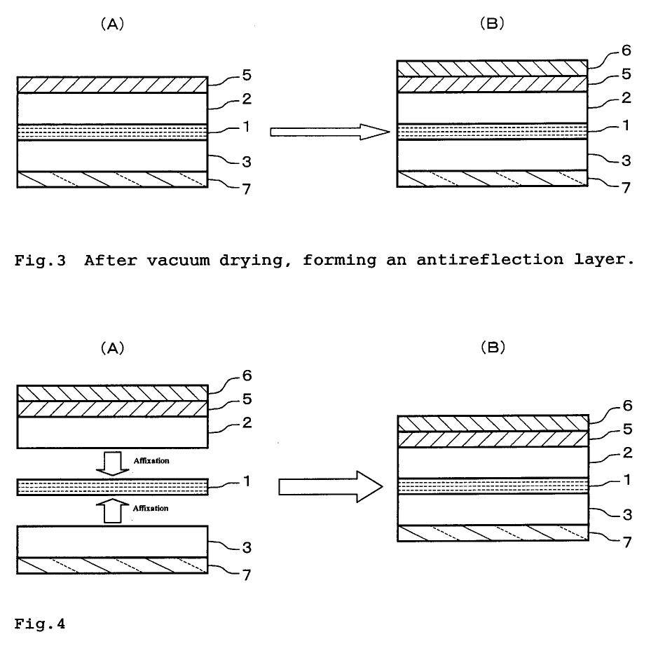

As shown in FIG. 3(A), a polarizer was produced by interposing a polarizing film 1 composed of an oriented film of iodine dye-polyvinyl alcohol between two transparent protective films 2 and 3 composed of triacetylcellulose. The first transparent protective film disposed on one side of the polarizing film 1 was a film providing a hard coated layer 5 produced by TOPPAN PRINTING CO., LTD. on one side of a triacetylcellulose film 2; the second transparent protective film disposed on the other side of the polarizing film 1 was a film providing an optical compensation layer 7 composed of an oriented coating layer of a discotic liquid crystal on one side of a triacetylcellulose film 3 via polyvinyl alcohol oriented film (not shown), which is produced by Fuji Photo Film Co., Ltd. with the trade name of “WV-SA”; and each of the protective films was affixed to the polarizing film 1 respectively with the side of triacetylcellulose films 2 or 3 thereof via an adhesive. The thickness of the polarizing film 1 was about 25 μm, that of the triacetylcellulose film 2 with the hard coated layer 5 was about 85 μm, and that of the triacetylcellulose film 3 with the optical compensation layer 7 was about 83 μm.

After the polarizer was subjected to drying treatment under vacuum, as shown in FIG. 3(B), an antireflection layer 6 composed of a metal oxide film was formed on the surface of the hard coated layer 5 with a sputtering method to express an antireflecting function and low water-vapor permeability. In this treatment, although an original value of the water-vapor permeability of the triacetylcellulose film 2 itself was 420 g/m²·24 hours, its water-vapor permeability value became 2.40 g/m²·24 hours after providing the hard coated layer 5 and antireflection layer 6 on the triacetylcellulose film 2. The triacetylcellulose film 2 before providing the hard coated layer 5 contained 6.7% by weight of triphenylphosphate and the triacetylcellulose film 3 with the optical compensation layer 7 (“WV-SA”) also contained 6.5% by weight of triphenylphosphate. The polarizer obtained had a water content of 1.74% by weight. Thus, obtained is a polarizer in which one of the protective films had the low water-vapor permeability of 2.40 g/m²·24 hours, both transparent protective films respectively contained less than 7% by weight of triphenylphosphate as a plasticizer, and the water content as a whole was about 1.7% by weight.

### Comparative Example 1

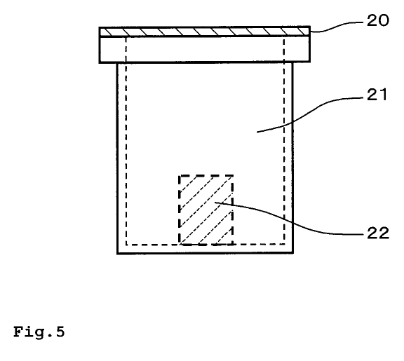

As shown in FIG. 4(A), one transparent protective film was prepared by providing a hard coated layer 5 produced by TOPPAN PRINTING CO., LTD. on one side of a triacetylcellulose film 2 and then forming an antireflection layer 6 composed of a metal oxide film on the surface of the hard coated layer 5 with a sputtering method to express an antireflecting function and low water-vapor permeability. Other transparent protective film applied a film same as the second transparent protective film used in Example 1, which was prepared by providing an optical compensation layer 7 composed of an oriented coating layer of a discotic liquid crystal on one side of a triacetylcellulose film 3 via an oriented film (trade name “WV-SA”). Thereafter, these two transparent protective films were respectively affixed to either side of a polarizing film 1 composed of an oriented film of iodine dye-polyvinyl alcohol with the side of triacetylcellulose films 2 or 3 thereof via an adhesive; as shown in FIG. 4(B), thus produced a polarizer which has a layer structure same as Example 1 and interposes the polarizing film 1 between two protective films. The thickness of each layer was same as that in Example 1.

The layer of triacetylcellulose film 2 had a water-vapor permeability of 2.40 g/m²·24 hours after being provided with the hard coated layer 5 and antireflection layer 6. The triacetylcellulose film 2 before being provided with the hard coated layer 5 contained 6.7% by weight of triphenylphosphate, and the triacetylcellulose film 3 with the optical compensation layer 7 (“WV-SA”) also contained 6.5% by weight of triphenylphosphate. The polarizer obtained had a water content of 2.78% by weight.

### Example of Evaluation Test

(a) Production of a Sample for Evaluation

Pieces with a size of 30 mm×30 mm or 100 mm×100 mm were cut out from the respective polarizers obtained in Example 1 and Comparative Example 1, followed by being respectively affixed to a glass plate via a pressure-sensitive adhesive to form samples for evaluation.

(b) Evaluation of Durability of Polarizer under a Wet-Heat Environment

The sample with the size of 30 mm×30 mm which was produced in the above (a) was subjected to a wet-heat resistance test on the basis of leaving at 60° C. under a relative humidity of 90% for 750 hours, followed by measurement of optical properties of the polarizer before and after the test. Measurement was carried out by using a spectrophotometer for ultraviolet and visible region “UV-2450” produced by SHIMADZU Corporation with applying its optional accessory “Film holder with polarizing film”, measuring transmission spectrums in the wavelength range of 380 nm to 700 nm at transmitting and absorbing directions of a polarizer, and determining color coordinates a* and b* of a transmitted light according to JIS Z 8729 and a polarization degree Py with using a software “UV-Probe” furnished to the above spectrophotometer.

A change of polarization degree ΔPy was calculated according to the following formula (II) based on a polarization degree Py after the wet-heat resistance test and an initial (before the wet-heat resistance test) polarization degree Py; and a hue change Δa*b* was calculated according to the following formula (III) based on a* and b* after the wet-heat resistance test and initial (before the wet-heat resistance test) a* and b*.

$$\begin{matrix}Δ Py = \vert Py after the test - Initial Py \vert & ( II ) \\ Δ {a}^{*} {b}^{*} = v \overline{{( {a}^{*} after the test - Initial {a}^{*} )}^{2} + {( {b}^{*} after the test - Initial {b}^{*} )}^{2}} & ( III )\end{matrix}$$

According to the results obtained, the polarizers of Example 1 and Comparative Example 1 respectively gave a polarization degree change ΔPy of 0.05 points or less in terms of the difference of polarization degrees (represented in percentage) and a hue change Δa*b* of 2 or less. These results prove that any of the polarizers exhibit a favorable durability under a wet-heat environment.

(c) Evaluation of Durability of Polarizer under a Dried and High Temperature Environment

The sample with the size of 100 mm×100 mm produced in the above (a) was subjected to a heat resistance test on the basis of leaving at 85° C. under a dried-high temperature environment for 750 hours, followed by observation of a sample appearance after the test. According to the observation, the sample obtained in Example 1 had no appearance deterioration, resulting in the favorable result; on the other hand, the sample obtained in Comparative Example 1 caused wrinkled defects on its surface, thereby the measurements regarding to optical properties such as polarization degree were impossible.

### Example 2 and Comparative Example 2

Following two kinds of films were prepared as a first transparent protective film.

Example 2: A film was prepared by providing a hard coated layer produced by TOPPAN PRINTING CO., LTD. on one side of a triacetylcellulose film and then forming an antireflection layer composed of a metal oxide film on the surface of the hard coated layer with a sputtering method to express an antireflecting function and low water-vapor permeability. The value of the low water-vapor permeability was 2.4 g/m²·24 hours.

Comparative Example 2 : A film was prepared by providing a hard coated layer produced by TOPPAN PRINTING CO., LTD. on one side of a triacetylcellulose film (i.e. a film before providing an antireflection layer to the film prepared in Example 2 described above). The water-vapor permeability value of this film was 296 g/m²·24 hours. This film has been generally used as a transparent protective film to be disposed on a displaying side of a polarizer.

A film used for a second transparent protective film was prepared by forming an oriented film composed of a polyvinyl alcohol-based resin on one side of a triacetylcellulose film and then forming a coating layer of a discotic liquid crystal (optical compensation layer) on the oriented film (trade name “WV-SA”, produced by Fuji Photo Film Co., Ltd.; this film was same as used in Example 1 and Comparative Example 1).

A polarizer was produced with using such first transparent protective film and second transparent protective film according to the procedure depicted in FIG. 4. That is, as shown in FIG. 4(A), on one side of a polarizing film 1 composed of an oriented film of iodine dye-polyvinyl alcohol, affixed was the above-mentioned first transparent protective film with the side of triacetylcellulose film 2 via an adhesive; and on the other side of the polarizing film 1, affixed was the above-mentioned second transparent protective film with the side of triacetylcellulose film 3 also via an adhesive. Thus, a polarizer constituted by interposing the polarizing film 1 between two protective films was produced as depicted in FIG. 4(B).

A layer of an acrylic pressure-sensitive adhesive (produced by Lintec Corporation, trade name “P236JP”) was disposed on the side of the optical compensation layer 7 of the second transparent protective film of thus obtained polarizer to produce a polarizer with pressure-sensitive adhesive layer. This polarizer with pressure-sensitive adhesive layer was humidified by leaving under an atmosphere of a temperature at 23° C. and a relative humidity of 50% for 3 days or more.

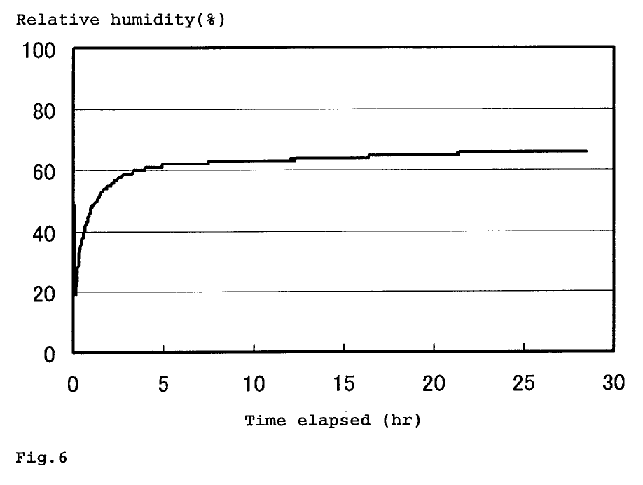

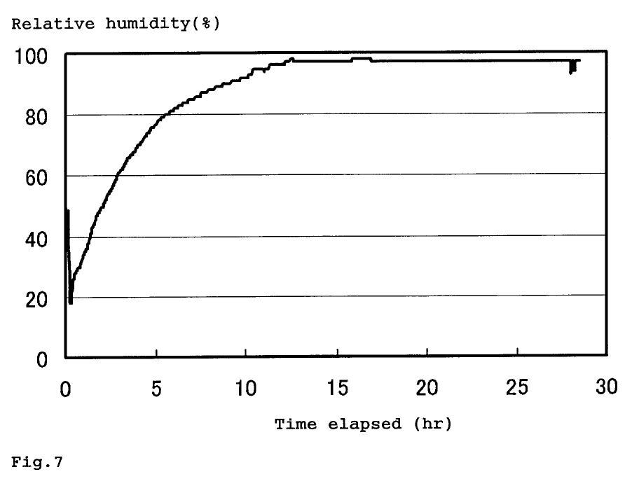

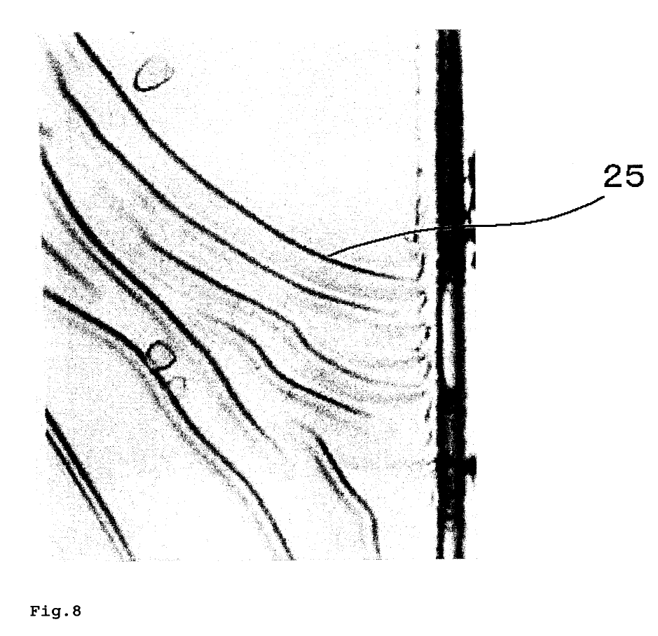

A water permeability was observed about this humidified polarizer with pressure-sensitive adhesive layer. FIG. 5 shows an outline of this water-permeability observation method. That is, a temperature-humidity meter 22 was installed in a glass vessel 21 of which wall was thick only at its upper-open edge, and the glass vessel 21 was sealed by affixing the upper-open edge with the side of the pressure-sensitive adhesive layer of the above-humidified polarizer 20. The glass vessel in this state was put in an oven conditioned at 60° C. with a relative humidity of 90%. Humidity changes in the glass vessel 21 was observed along a lapse of time, and the result of Example 2 is shown in FIG. 6 and that of Comparative Example 2 is shown in FIG. 7.

According to the figures, the following are proved: in the case of Example 2 (FIG. 6) using the polarizer with the first transparent protective film having the water-vapor permeability of 2.4 g/m²·24 hours, after 1 to 2 hours had passed, the humidity in the glass vessel did not increase so much even if the time elapsed much longer, thereby water permeation through the surface of the polarizer was suppressed; on the contrary, in the case of Comparative Example 2 (FIG. 7) using the polarizer with the first transparent protective film having the water-vapor permeability of 296 g/m²·24 hours, the humidity in the glass vessel reached to a level as much as the outside atmosphere at an early stage just after commencement of the test, thereby abundant water permeated through the surface of the polarizer.

### Example 3

The polarizer with pressure-sensitive adhesive layer which was produced in Example 2 was cut into chips with about 8 inches (200 mm) width across corner in the manner that the absorption axis of the chip was in an angle of 45 degree in anti-clockwise rotation with respect to the long side thereof, the chip cut was affixed to a glass plate having 1.1 mm thickness with the side of the pressure-sensitive adhesive layer thereof to form a sample; thereafter, this sample was pressed with conditions at 50° C. under 5 atmospheric pressure for 20 minutes, and then left for 24 hours. Thereafter, the sample was put in a high temperature and humidity oven conditioned at 65° C. with a relative humidity of 90%, followed by taken out from the oven after 65 hours elapsed to be subjected to an appearance observation, thereby generation of defects such as peeling or blistering was not found on the sample.

### Comparative Example 3

The polarizer with pressure-sensitive adhesive layer which was produced in Comparative Example 2 was subjected to a test in the same way as in Example 3. FIG. 8 exhibits a closeup picture of the polarizer at an edge thereof taken after the test. Blistering was generated between the layers of the second transparent protective film with polyvinyl alcohol oriented film (“WV-SA”); and especially, a large number of tunnelings 25 were observed at the edge of the polarizer.

What is claimed is;:

1. A polarizer comprising a polarizing film, a first transparent protective film and a second transparent protective film, the polarizing film being between the first transparent protective film and the second transparent protective film, wherein the first transparent protective film has a water-vapor permeability of 50 g/m²·24 hours or less at 40° C. under a relative humidity of 90% and a water content of the polarizer is 2.0% by weight or less.

2. The polarizer according to claim 1, wherein the first transparent protective film has a surface-treated surface opposite to the polarizing film.

3. The polarizer according to claim 2, wherein the first transparent protective film is has a surface-treated surface of a water-vapor permeability of 50 g/m²·24 hours or less at 40° C. under a relative humidity of 90%.

4. The polarizer according to claim 3, wherein the first transparent protective film comprises a cellulose resin.

5. The polarizer according to claim 4, wherein the first transparent protective film contains 3 to 10% by weight of triphenylphosphate.

6. The polarizer according to claim 1, wherein the first transparent protective film has an antireflection layer opposite to the polarizing film.

7. The polarizer according to any one of claims 1 to 6, wherein the second transparent protective film has an optical compensation layer opposite to the polarizing film.

8. A polarizer comprising a polarizing film, a first transparent film and a second transparent protective film, the polarizing film being between the first transparent protective film and the second transparent protective film, wherein the first transparent protective film has a water-vapor permeability of 50 g/m²·24 hours or less at 40° C. under a relative humidity of 90%, and the second transparent protective film has layer of a transparent support including a cellulose resin, a hydrophilic oriented film, and a coating layer of a liquid crystal compound in this order and affixed to the polarizing film at the side of the transparent support thereof.

9. The polarizer according to claim 8, wherein the first transparent protective film has a surface-treated surface opposite to the polarizing film.

10. The polarizer according to claim 9, wherein the first transparent protective film has a surface-treated surface to have a water-vapor permeability of 50 g/m²·24 hours or less at 40° C. under a relative humidity of 90%.

11. The polarizer according to claim 10, wherein the first transparent protective film comprises a cellulose resin.

12. The polarizer according to claim 11, wherein the first transparent protective film contains 3 to 10% by weight of triphenylphosphate.

13. The polarizer according to claim 8, wherein the first transparent protective film has an antireflection layer opposite to the polarizing film.

14. The polarizer according to any one of claims 8 to 13, wherein the hydrophilic oriented film comprises a polyvinyl alcohol resin.

15. The polarizer according to claims 8 to 13, wherein the coating layer is an optical compensation layer including a discotic liquid crystal.

16. The polarizer according to claim 15, wherein the optical compensation layer is a negative birefringent layer comprising a liquid crystal compound with discotic structural units, wherein a disk face of the discotic structural units is tilted with respect to the plane of the transparent support, and an angle formed by the disc face of the discotic structural units and the plane of the transparent support varies along the thickness direction of the optical compensation layer.

17. An optical compensation sheet comprising the polarizer according to claim 16, wherein the angle formed by the disc face of the discotic structural units and the plane of the transparent support increases as a distance in the optical compensation layer from the transparent support increases along the thickness direction of the optical compensation.

18. The polarizer according to claim 8, wherein a pressure-sensitive adhesive layer is on an outer side of the coating layer of a liquid crystal compound of the second transparent protective film.

19. A liquid crystal display comprising a liquid crystal cell and the polarizer according to any one of claim 1 or 8, wherein the liquid crystal cell is affixed to the polarizer with the side of the second transparent protective film thereof via a pressure-sensitive adhesive layer.
